(19) United States
(12) Patent Application Publication
(10) Pub. No.: US 2008/0186800 A1
(43) Pub. Date: Aug. 7, 2008

(54) Disposable Holder Cum Stirrer

(76) Inventors: Shirazali Sadrudin Jaffer, Queensland (AU); Reshma Shiraz Jaffer, Queensland (AU)

Correspondence Address: SHIRAZALI JAFFER, 33 NORTHWESTERN COURT, VARSITY LAKES, 4227, omitted

(21) Appl. No.: 11/815,310

(22) PCT Filed: Jul. 12, 2005
(86) PCT No.: PCT/AU05/01013

§ 371 Date: Aug. 1, 2007

(30) Foreign Application Priority Data
Feb. 7, 2005 (AU) 10465/2005

(51) Int. Cl. B01F 13/00

(52) U.S. Cl. 366/129

(57) ABSTRACT

The disclosed disposable holder cum stirrer is a device for holding and stirring a chunk, block or mass of any substance in a liquid. It is made up of three distinct parts namely the top handle (7), the connecting stick (8) and the bottom clamp (9) seamlessly fused together to form one independent design (FIG. 1). The bottom clamp (9) is made up of three flexible prongs (11). Each Prong (11) is a specific shape (FIG. 6) which has two right angle edges. Each of these prongs (11) meet at their top most point (12) and are joined to the connecting stick (8) at this common point (12). This unique three prong design enables the device to hold, grip or grasp the said chunk, block or mass in a specific manner and also enables the device to be used as a stirrer to stir the said chunk, block or mass in a liquid.

The following statement is a full description of this invention, a disposable holder cum stirrer (henceforth referred to as the “said device” in this document), including the best method of utilizing it known to us.

The “said device” is specifically invented to create a new method with which a chunk, block or mass of any substance (e.g.: a sugar cube, a nutritional supplement tablet, a soup dice etc) may be held, packaged, immersed, stirred and dissolved in a liquid with the assistance of the “said device”. The said chunk, block or mass of substance is henceforth referred to as the “said contents” in this document.

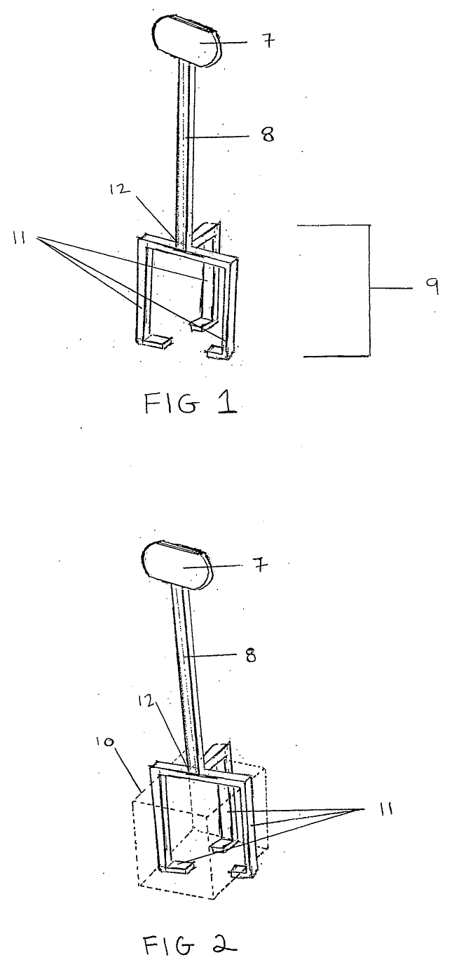

The “said device” FIG. 1 in accordance with this invention is made up of three distinctive parts seamlessly fused together. The top handle 7, the connecting stick 8 and the bottom clamp 9.

The top handle 7 is the part which the consumer holds to use the “said device”. In FIG. 1 the shape of the top handle 7 is oval. However, the shape of the top handle 7 may be round, square, triangular, or any other two dimensional or three dimensional shape e.g. a miniature animal shape, a shape of a company logo.

The connecting stick 8 connects the top, handle 7 to the bottom clamp 9 and assists in the stirring process. The cross sectional shape of the connecting stick 8 may be round, triangular, square, rectangular, or any other viable shape.

The bottom clamp 9 holds the “said contents” and it too assists in the stirring process. It is unique in its design and use, in that it has three prongs 11. Each prong 11 is a specific shape FIG. 6 with two right angle edges. The three prongs 11 meet at point 12. Together the three prongs 11 make up the clamp 9. The clamp 9 is joined to the connecting stick 8 at point 12. The prongs 11 are intended to be made of flexible material e.g. flexible food grade plastic. A combination of the unique cavity formed by the design of the clamp 9 and the flexibility provided by the material used for the prongs 11, holds the “said contents” snugly. The cross sectional shape of a prong 11 may be round, triangular, square, rectangular or any other viable shape.

Till date, we believe there is no known single piece of disposable equipment whose design and utility capabilities meet that of the “said device” as described above and further stated below.

The “said device” FIG. 1 is designed to hold, grip or grasp the “said contents” in a specific manner as illustrated in FIG. 2.

The “said contents” 10 may be attached to the “said device” at clamp 9 thus forming a combination unit consisting of the “said contents” and the “said device”. This combination unit of the “said device” and the “said contents” is now referred in this document as a “combined unit” FIG. 2.

The “combined unit” may be packed individually in its own wrapper or more than one “combined unit” may be packed together in one packaging.

The “combined unit”, while still in its packaging, may be transported to a point of consumption for future or immediate use.

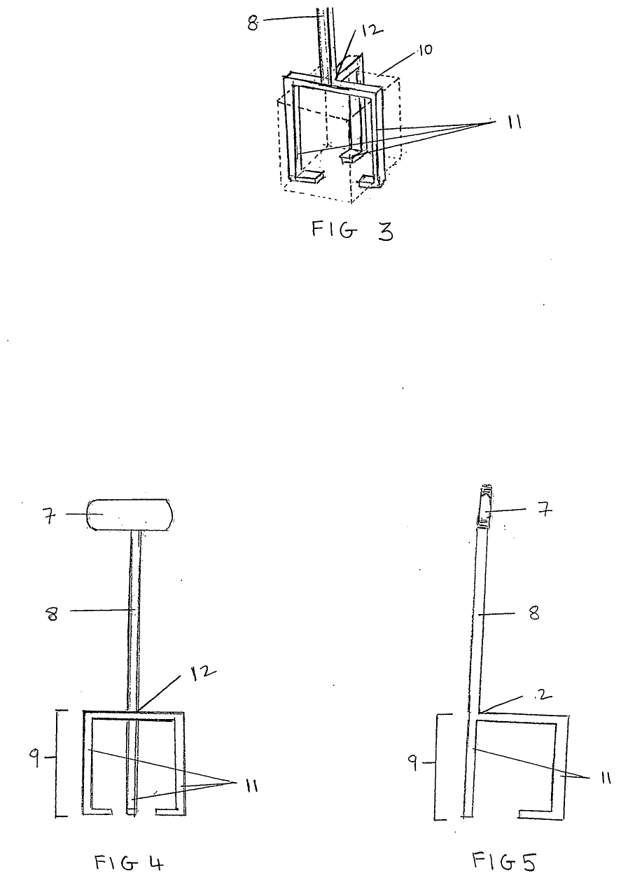

At the time of consumption (after the “combined unit” is removed from its packaging) the consumer can dissolve the “said contents” held by the “combined unit” in a container containing liquid utilizing the “combined unit”. This is achieved by holding the “combined unit” by its handle 7, immersing the bottom part of the “combined unit” FIG. 3 in a container containing liquid (e.g. a tea cup, a glass, a coffee mug, a soup bowl, or any other container) and stirring the liquid using the “combined unit” as a stirrer until the “said contents” dissolves in the liquid.

The “said device” is intended to be economical and disposable in nature. Hence it is intended that the “said device” be made from suitable food grade plastic. However other materials may also be used for example glass, metal or combinations thereof.

The invention may be better understood with reference to the illustrations of embodiments of the invention which:

FIG. 1 is a three dimensional view of the “said device” as it would be manufactured.

FIG. 2 is a three dimensional view of the “combined unit”. It consists of the “said device” as it would be manufactured plus the “said contents” (dotted) attached to the “said device”.

FIG. 3 is a three dimensional view of the bottom part of the “said device” with the “said contents” dotted.

FIG. 4 and FIG. 5 are front and side views of the “said device” respectively.

FIG. 6 is a side view of an individual prong

The “said device” consists of a handle 7, a connecting stick 8 and a clamp 9. The said contents 10 are held by the clamp 9. Clamp 9 is made up of three prongs 11 which meet one another and join the connecting stick 8 at 12.

1-21. (canceled)

22. A disposable holder cum stirrer comprising of three distinct parts namely at least one handle, at least one elongated member and at least one holder seamlessly fused together to form one independent device which fulfills the functions of holding a chunk, block or mass, of any substance and assists in stirring the said chunk, block or mass in a liquid and is made from any suitable single food grade or non food grade material or combination of any suitable food grade or non food grade material.

23. A disposable holder cum stirrer as claimed in claim 22 wherein said holder is made up of at least one prong, which may be stiff, flexible or malleable and shape and cross-section of each said prong varies to suit holding at least a piece of at least one chunk, block or mass of any substance in an optimum manner.

24. A disposable holder cum stirrer as claimed in claim 22 wherein said handle may be of any three dimensional shape including it being an extension of said elongated member and is either in solid or hollow form, any may have advertising material placed on or around it and where said handle is hollow it may have extremities either open at one end, or at both ends or closed at both ends.

25. A disposable holder cum stirrer as claimed in claim 22 wherein said elongated member is made up of at least one solid or hollow conduit, rod, pipe or tube where either the entire or part of the said conduit(s), rod(s), pipe(s) or tubes may be straight, curved, bent at angle(s), curved and bent at angle(s), squiggled, joined intermittently or continuously, or placed side by side and where said elongated member is hollow it may have extremities open at one end, or at both ends or closed at both ends.

26. A disposable holder cum stirrer as claimed in claims 24 and 25 wherein when said elongated member is hollow and open at both ends and said handle is also hollow and open at both ends the disposable holder cum stirrer may be used as a drinking straw to draw the liquid by sucking through the said elongated member and said handle.

27. A disposable holder cum stirrer as claimed in claim 22 wherein said elongated member or said handle or both have a clip(s) placed at an appropriate place to hang the said disposable holder cum stirrer on the edge of a container resting inside or outside the container and in addition to said clip(s) said elongated member may also have one or more free falling collar(s).

28. A disposable holder cum stirrer as claimed in claim 22 wherein holder means comprises of a clamp with a flexible three prong design, handle means comprises of an oval shaped flat disc, elongated member comprises of a stick, where said clamp is fixed at one extremity and said handle is fixed at the other extremity of said stick and where said disposable holder cum stirrer is made from food grade plastic.

29. A combined unit comprising of said disposable holder cum stirrer as claimed in claim 22 wherein said holder holds at least a chunk, block or mass of any substance.

30. A disposable holder cum stirrer as claimed in claim 22 and 29 wherein said holder has a bag like covering made from any porous, permeable, semi-permeable or any other suitable material around it.

31. A disposable holder cum stirrer as claimed in claim 22 where in said disposable holder cum stirrer may have one or more seam(s), groove(s), ridge(s) anywhere on said holder cum stirrer wherein said seam(s), groove(s), ridge(s) do not play a function of holding any said fused parts together, but appear externally only.

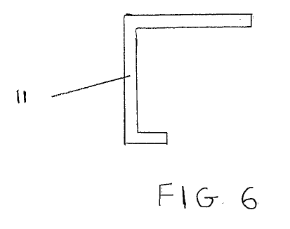

32. A disposable holder cum stirrer substantially as herein before described with reference in the text and the accompanying drawings of FIG. 1 to FIG. 6, FIG. 13 to FIG. 21, FIG. 23 to FIG. 25, FIG. 28 to FIG. 30, FIG. 33, FIG. 35 and FIG. 49.
